(19) United States
(12) Patent Application Publication
(10) Pub. No.: US 2009/0158401 A1
(43) Pub. Date: Jun. 18, 2009

(54) DOWNLOADABLE CONDITIONAL ACCESS SYSTEM AND CONTROLLING METHOD FOR THE SAME

(76) Inventors: Heejeong KIM, Daejeon (KR); Eun Jung KWON, Daejeon (KR); Soon Choul KIM, Daejeon (KR); Young Ho JEONG, Daejeon (KR); O Hyung KWON, Daejeon (KR); Soo In LEE, Daejeon (KR)

Correspondence Address: LADAS & PARRY LLP, 224 SOUTH MICHIGAN AVENUE, SUITE 1600, CHICAGO, IL, 60604, US

(21) Appl. No.: 12/327,224

(22) Filed: Dec. 3, 2008

(30) Foreign Application Priority Data
Dec. 18, 2007 (KR) 10-2007-0132955
Feb. 14, 2008 (KR) 10-2008-0013608

(51) Int. Cl. G06F 21/20

(52) U.S. Cl. 726/4

(57) ABSTRACT

A method and apparatus of supporting a fee-based broadcasting service in a Downloadable Conditional Access System (DCAS) is provided. A control method of a DCAS, the method including: receiving a Conditional Access (CA) image file from a Conditional Access System (CAS) server and receiving Integrated Personalization Server (IPS) access information from an IPS; providing an Authentication Proxy (AP) with information about the received CA image file; controlling the AP to provide a terminal with access information to the IPS and image installation information when the terminal joins a fee-based service based on verifying device information of the terminal; and controlling the IPS to enable the terminal to receive a CA image code of the terminal based on the access information and the image installation information.

### CROSS-REFERENCE TO RELATED APPLICATION

This application claims priority from Korean Patent Application No. 10-2007-0132955, filed on Dec. 18, 2007, and Korean Patent Application No. 10-2008-0013608, filed on Feb. 14, 2008, in the Korean Intellectual Property Office, the entire disclosure of both of which are incorporated herein by reference.

### BACKGROUND OF THE INVENTION

1. Field of the Invention

The present invention relates to a method of verifying whether an authenticated terminal joins a fee-based broadcasting service and transmitting an appropriate Conditional Access (CA) application program in order to provide a Downloadable Conditional Access System (DCAS), and apparatus using the method.

This work was supported by the IT R&D program of MIC/IITA [2007-S-007-01, The Development of Downloadable Conditional Access System].

2. Description of Related Art

A Conditional Access System (CAS) corresponds to a system of permitting a viewing authority with respect to fee-based broadcasting to only authenticated subscribers. A terminal of the CAS includes a function of managing a Conditional Access (CA) key and decrypting an encrypted received signal to enable viewing using the CA key, and this function is referred to as a CA module. The CAS applied to legacy digital cable broadcasting embodies the CA module as a cable card type, however, as problems with respect to high costs of a cable card, inefficient management capability in the case of emergencies, and the like occur, a Downloadable Conditional Access System (DCAS) of securely downloading a CA application program corresponding to the CA module embodied in software to an authenticated subscriber terminal to support a CA service for a subscriber and to provide a service operator with a capability of remotely composing or resetting a CA scheme is proposed.

The terminal downloading a common CA image after the DCAS completes authentication has the same qualifications as the terminal with an installed cable card type receiving module in the legacy CAS. In order to provide the terminal with the CA service, a CAS master key needs to be stored in the terminal, and an Entitlement Management Message (EMM) corresponding to a CA entitlement signal based on the master key needs to be transmitted by the CAS. A method of transmitting the CAS master key to a fee-based broadcasting service subscriber terminal and a method of reflecting, in the EMM, a receiving qualification authority appropriate for purchasing contents by the subscriber need to be provided.

A CAS service provider may directly assign the CAS master key to the terminal and may simultaneously reflect, in the EMM, entitlement with respect to the key in the legacy CAS, however, the DCAS provides the terminal with the CAS master key passing through the DCAS other than the CAS service provider. Accordingly, a method of providing an authenticated terminal with a master key in the DCAS and a method of enabling the CAS service provider managing the EMM to recognize CAS master key information included in each subscriber terminal are required.

### SUMMARY OF THE INVENTION

An aspect of the present invention provides a method of supporting a Conditional Access (CA) service for a terminal downloading a CA image from a Downloadable Conditional Access System (DCAS) after a fee-based broadcasting service is paid for in advance, and enabling the terminal being connected with the DCAS and downloading the CA image without a prior payment process to apply the fee-based broadcasting service and to use the CA service. In the DCAS, a service with respect to the terminal sold through a manufacturer and at retail needs to be considered.

Another aspect of the present invention also provides a method of supporting a CA service for a subscriber terminal paying for a fee-based broadcasting service and a reserve subscriber terminal not paying for the fee-based broadcasting service in a DCAS.

According to an aspect of the present invention, there is provided a control method of a DCAS, the method including: receiving a CA image file from a Conditional Access System (CAS) server and receiving Integrated Personalization Server (IPS) access information from an IPS; providing an Authentication Proxy (AP) with information about the received CA image file; controlling the AP to provide a terminal with access information to the IPS and image installation information when the terminal joins a fee-based service based on verifying device information of the terminal; and controlling the IPS to enable the terminal to receive a CA image code of the terminal based on the access information and the image installation information.

According to another aspect of the present invention, there is provided a DCAS including: a receiving unit to receive a CA image file from a CAS server and to receive IPS access information from an IPS; a transmitting unit to provide an AP with information about the received CA image file; and a control unit to control the AP to provide a terminal with access information to the IPS and image installation information when the terminal joins a fee-based service based on verifying device information of the terminal, and to control the IPS to enable the terminal to receive a CA image code of the terminal based on the access information and the image installation information.

### BRIEF DESCRIPTION OF THE DRAWINGS

The above and other aspects of the present invention will become apparent and more readily appreciated from the following detailed description of certain exemplary embodiments of the invention, taken in conjunction with the accompanying drawings of which:

FIG. 1 illustrates a Downloadable Conditional Access System (DCAS) configuration and an application program download process for a fee-based broadcasting subscriber of prior payment according to an exemplary embodiment of the present invention;

FIG. 2 illustrates a DCAS configuration and an application program download process for a fee-based broadcasting subscriber of post payment according to an exemplary embodiment of the present invention; and

FIG. 3 is a flowchart illustrating a process of processing a Conditional Access (CA) image file to be transmitted to a terminal authenticated by an Authentication Proxy (AP) according to an exemplary embodiment of the present invention.

### DETAILED DESCRIPTION OF EXEMPLARY EMBODIMENTS

Reference will now be made in detail to exemplary embodiments of the present invention, examples of which are illustrated in the accompanying drawings, wherein like reference numerals refer to the like elements throughout. The exemplary embodiments are described below in order to explain the present invention by referring to the figures.

When detailed descriptions related to a well-known related function or configuration are determined to make the spirits of the present invention ambiguous, the detailed descriptions will be omitted herein. Also, terms used throughout the present specification are used to appropriately describe exemplary embodiments of the present invention, and thus may be different depending upon a user and an operator's intention, or practices of application fields of the present invention. Therefore, the terms must be defined based on descriptions made through the present invention.

In order to achieve a purpose of the present invention, an exemplary embodiment of the present invention characteristically includes a Conditional Access System (CAS) master key in a Conditional Access (CA) image provided for a terminal through a Downloadable Conditional Access System (DCAS) by a CAS service provider, and characteristically classifies the CA image into the CA image for a fee-based subscriber terminal purchasing the CA image in advance and the CA image for a reserve subscriber terminal not purchasing the CA image.

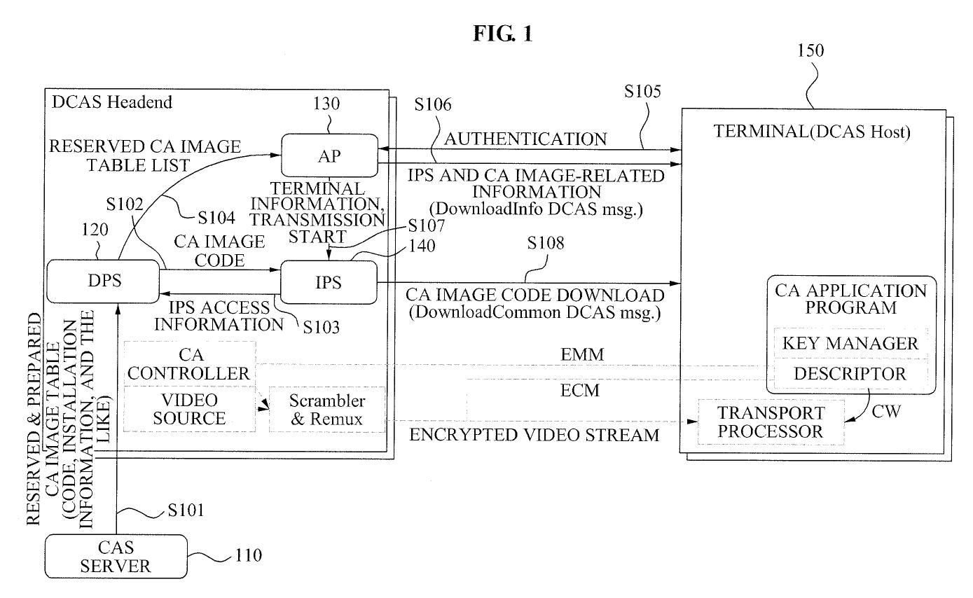

FIG. 1 illustrates a DCAS configuration and an application program download process for a fee-based broadcasting subscriber of prior payment according to an exemplary embodiment of the present invention.

Hereinafter, referring to FIG. 1, the DCAS configuration and the application program download process for the fee-based broadcasting subscriber of prior payment according to an exemplary embodiment of the present invention are described.

As illustrated in FIG. 1, the DCAS includes a CAS server 110, a DCAS Provisioning System (DPS) 120 to perform an operator function, an Authentication Proxy (AP) 130 to perform a function of a window and an authentication server of a server with respect to a terminal, an Integrated Personalization Server (IPS) 140 to perform a transmission server function of a CA application program, and a terminal (a DCAS host) 150, and the process of providing a CA service is described below.

The CAS server 110 of the CAS service provider generates a “reserved” CA image file for the fee-based subscriber each time a user pays for the fee-based broadcasting service to provide the DPS 120 with the “reserved” CA image file. The CA image includes the CAS master key and the CA application program appropriate for a unique operating environment of a subscriber terminal. In operation S101, the CAS server 110 also transmits a “prepared” CA image file for a reserve subscriber to the DPS 120.

The CAS server 110 denotes information concerning whether each CA image corresponds to a “reserved” type CA image for the specific fee-based subscriber of prior payment or whether each CA image corresponds to a “prepared” type CA image for the reserve subscriber of post payment, and includes an image identifier, driving environment information including a software (s/w) and hardware (h/w) version of the terminal, a binary image code, metadata of an image code, device information of the corresponding terminal in the case of an image for the specific fee-based subscriber, and the like.

TABLE 1

| | | Field_Name | Description |
|---|---|---|---|
| CAImage_Table_List | CAImage_Table₁ | CAImage_Id 201 | CAImage identifier. |
| 210 | | CAImage_Type | “Reserved”\|“Prepared” |
| | | 202 | |
| | | Target_Host_Id | Device information of |
| | | 203 | terminal to install |
| | | | CAImage of “Reserved” |
| | | | type. Null value in the |
| | | | case of CAImage of |
| | | | “Prepared” type. |
| | | Target_Host_Conf | Terminal driving |
| | | 204 | environment including |
| | | | s/w version and h/w |
| | | | version |
| | | CAImage_Code_Metadata | version, size, directory |
| | | 205 | structure, and installation |
| | | | information of CAImage |
| | | | Code |
| | | CAImage_Code | Binary image code. |
| | | 206 | |

| . . . | |
|---|---|
| CAImage_Tableₙ | . . . |

In operations S102 and S103, the DPS 120 transmits the binary image code 206 of CA image information received from the CAS server 110 to the IPS 140, and image file location information (IPS access information) required for enabling the terminal to download an image file is returned to the DPS 120.

In operation S104, the DPS 120 provides the AP 130 with CA image information 201 through 205 for the fee-based subscriber terminal corresponding to the “reserved” type, and IPS access information 301 to be provided for an authenticated fee-based subscriber terminal. The CA image information includes the driving environment of the terminal, a size and a version of the image file, and the like, and the IPS access information includes a transmission mechanism (Digital Storage Media Command and Control (DSM-CC), a Trivial File Transfer Protocol (TFTP), and HyperText Transfer Protocol (HTTP)) required for enabling the terminal to acquire the image file, an address (a Uniform Resource Identifier), a file location, and a file name. Information provided for the AP 130 by the DPS 120 is described below in Table 2.

In operation S105, the AP 130 subsequently passes through a mutual authentication process with respect to the terminal 150, and acquires the device information of the authentication-completed terminal and the driving environment information.

When the device information of the terminal 150 is verified as including a fee-based subscriber list, the AP 130 finds the CA image corresponding to the subscriber and provides the terminal 150 with the related IPS access information 301 and the installation information 205 in operation S106, and commands the IPS 140 to transmit the corresponding CA image in operation S107. In operation S108, the IPS 140 having received a command to transmit the corresponding CA image transmits the image code to the terminal 150. Depending on a transmission scheme, for example, the DSM-CC and the TFTP, the terminal 150 may directly access the IPS 140, and the IPS 140 may directly transmit the image code to the terminal 150. Finally, when the terminal 150 installs and drives the image according to a guide provided by the AP 130 in operation S106, the CA service starts. Operations S106 and S108 respectively correspond to CA image-related information (a DownloadInfo DCAS message) and a CA image code (a DownloadCommon DCAS message).

TABLE 2

| | | Field_Name | Description |
|---|---|---|---|
| Reserved_CAImage_Table_List | Reserved_CAImage_Table₁ | CAImage_Id 201, | |
| 310 | | Target_Host_Id 203, | |
| | | Target_Host_Conf 204, | |
| | | CAImage_Code_Metadata 205 | |
| | | IPS_Info 301 | IPS access |
| | | | information to be |
| | | | transmitted to |
| | | | terminal, IPS access |
| | | | information |
| | | | including |
| | | | delivery_mechanism, |
| | | | IPS address, Dir Path, |
| | | | file name, and the |
| | | | like |
| | | Assigned_IPS_Id 302 | IPS identifier |
| | | | including CAImage |
| | | | Code. |

| . . . | |
|---|---|
| CAImage_Tableₙ | . . . |

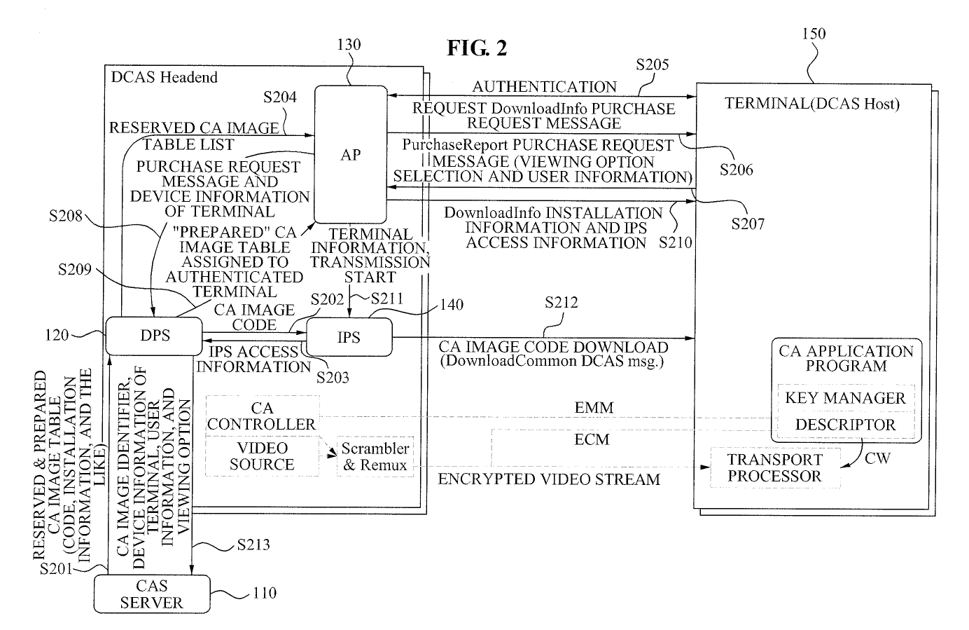

FIG. 2 illustrates a DCAS configuration and an application program download process for a fee-based broadcasting subscriber of post payment according to an exemplary embodiment of the present invention.

Hereinafter, referring to FIG. 2, the DCAS configuration and the application program download process for the fee-based broadcasting subscriber of post payment according to an exemplary embodiment of the present invention are described.

An exemplary embodiment of the present invention provides a CA service with respect to a terminal other than a fee-based subscriber of prior payment, and a process thereof is illustrated in FIG. 2. This particular exemplary embodiment is similar to a case of the fee-based subscriber that the CAS server 110 transmits a CA image to the DPS 120 and the AP 130 passes through an authentication process (operations S201 through S205) with respect to the terminal 150.

In operation S206, when the terminal 150 is different from the fee-based subscriber after authentication with respect to the terminal 150 is completed, the AP 130 provides the terminal 150 with a selectable fee-based broadcasting service viewing option using a DownloadInfo DCAS message. In operations S207 and S208, when a fee-based broadcasting payment request message (a Payment Report DCAS message) including desired viewing option selection and user information arrives from the terminal 150, the AP 130 transmits this information to the DPS 120.

In operation S209, the DPS 120 selects a single new CA image appropriate for a driving environment of the authenticated terminal from a “prepared” CA image list to transmit the new CA image to the AP 130. In operations S210 and S211, the AP 130 having received the CA image transmits the IPS access information 301 and the installation information 205 (the DownloadInfo DCAS message) to a new subscriber terminal, and commands the IPS 140 to transmit the IPS access information 301 and the installation information 205, similar to a case of the “reserved” type CA image. After download of the CA image is completed in operation S212, the DPS 120 transmits the identifier 201 of the “prepared” CA image selected for the new subscriber terminal, user information, and the selected viewing option to the CAS server 110 in operation S213.

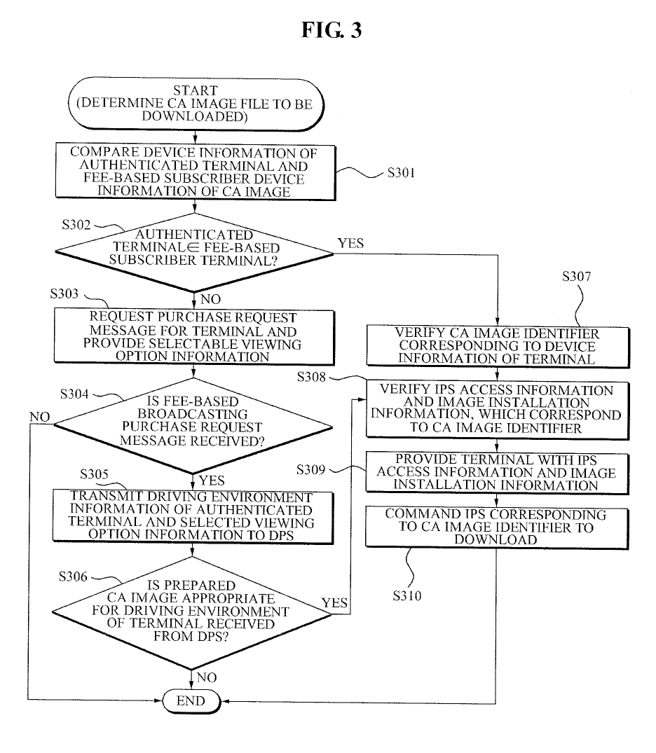

FIG. 3 is a flowchart illustrating a process of processing a CA image file to be transmitted to a terminal authenticated by an AP according to an exemplary embodiment of the present invention.

As described above, an exemplary embodiment of the present invention classifies a CA image transmitted from a DCAS to the terminal into an image for a fee-based subscriber terminal of prior payment and an image for a reserve subscriber terminal of post payment to provide the CA image, and determines whether prior payment is performed based on device information of a subscriber terminal. It is obvious that an exemplary embodiment of the present invention may provide a fee-based broadcasting selection option selected by a user during a process of requesting a payment request message for the terminal using a DownloadInfo DCAS message, and the terminal may request payment while providing the DCAS with a selected viewing option and user information using a Payment Report DCAS message, and the DCAS may provide a CAS service provider with a CA image identifier transmitted to a new subscriber, the device information of the terminal, and the user information, thereby supporting a CA service with respect to a subscriber.

For this, in operation S301, the process compares the device information of the authenticated terminal and fee-based subscriber device information of the CA image. When the terminal corresponds to the fee-based subscriber terminal corresponding to the fee-based broadcasting subscriber of prior payment based on a result of the comparing in operation S302, the process verifies the CA image identifier corresponding to the device information of the terminal in operation S307, and verifies access information to the IPS 140 and image installation information, which correspond to the CA image identifier, in operation S308.

In operation S309, after the verifying of the IPS access information and the image installation information, the process provides the terminal with the IPS access information and the image installation information. In operation S310, the process commands the IPS 140 corresponding to the CA image identifier to download. Accordingly, a process of determining and processing a CA image file to be transmitted to the terminal authenticated by the AP 130 is completed.

However, in operation S303, when the device information of the authenticated terminal is different from the fee-based subscriber terminal corresponding to the fee-based broadcasting subscriber of prior payment, that is, in the case of the subscriber of post payment, the process requests a payment request message for the terminal and provides selectable viewing option information.

When a fee-based broadcasting payment request message is received according to a message request in operation S304, the process transmits driving environment information of the authenticated terminal and the selected viewing option information to the DPS 120 in operation S305. Whether the prepared CA image appropriate for a driving environment of the terminal is received from the DPS 120 is determined in operation S306, and when the image cannot be received, the process is terminated.

When the prepared CA image appropriate for the driving environment of the terminal is received from the DPS 120, the process provides information about the corresponding terminal as the fee-based broadcasting subscriber of post payment, and passes through operations S308 through S310 similar to a case of the fee-based broadcasting subscriber of prior payment.

The control method of the DCAS according to the above-described exemplary embodiments may be recorded in computer-readable media including program instructions to implement various operations embodied by a computer. The media may also include, alone or in combination with the program instructions, data files, data structures, and the like. The media and program instructions may be those specially designed and constructed for the purposes of the present invention, or they may be of the kind well-known and available to those having skill in the computer software arts. Examples of computer-readable media include magnetic media such as hard disks, floppy disks, and magnetic tape; optical media such as CD ROM disks and DVD; magneto-optical media such as optical disks; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations of the above-described embodiments of the present invention.

According to the present invention, a DCAS may support authentication and CA image transmission for a fee-based subscriber terminal completing payment for a fee-based broadcasting service and a reserve subscriber terminal not passing though a payment process, thereby providing a CA service.

Also, according to the present invention, it is possible to register a CA image for a reserve subscriber in a DCAS in advance, thereby minimizing real-time interaction between the DCAS and a CAS and a waiting time of a terminal during a registration process of a new subscriber.

Although a few exemplary embodiments of the present invention have been shown and described, the present invention is not limited to the described exemplary embodiments. Instead, it would be appreciated by those skilled in the art that changes may be made to these exemplary embodiments without departing from the principles and spirit of the invention, the scope of which is defined by the claims and their equivalents.

What is claimed is:

1. A control method of a Downloadable Conditional Access System (DCAS), the method comprising:
receiving a Conditional Access (CA) image file from a Conditional Access System (CAS) server and receiving Integrated Personalization Server (IPS) access information from an IPS;
providing an Authentication Proxy (AP) with information about the received CA image file;
controlling the AP to provide a terminal with access information to the IPS and image installation information when the terminal joins a fee-based service based on verifying device information of the terminal; and
controlling the IPS to enable the terminal to receive a CA image code of the terminal based on the access information and the image installation information.

2. The method of claim 1, wherein the receiving of the CA image file and receiving of the IPS access information and the providing comprises:
receiving the IPS access information required for downloading an image file; and
providing the AP with predetermined information of the CA image file received from the CAS server.

3. The method of claim 2, further comprising:
receiving, from the AP, fee-based broadcasting payment request message information including viewing option selection requested by the terminal, and user information;
selecting a new CA image appropriate for an operating environment of an authenticated terminal from a prepared CA image list to transmit the new CA image to the AP; and
transmitting, to the CAS server, an identifier of a prepared CA image selected for a new subscriber terminal, the user information, and the selected viewing option after the transmitting of the new CA image.

4. The method of claim 1, wherein the controlling of the AP comprises:
controlling the AP to verify a received CA image identifier corresponding to device information of the terminal when the terminal corresponds to a fee-based subscriber terminal based on comparing the device information of the terminal and fee-based subscriber device information of a CA image;
controlling the AP to verify the IPS access information and the image installation information, which correspond to the CA image identifier, after the verifying;
controlling the AP to provide the terminal with the IPS access information and the image installation information; and
controlling the AP to command the IPS corresponding to the CA image identifier to download to the terminal.

5. The method of claim 4, further comprising:
controlling the AP to request a payment request message for the terminal and to provide the terminal with selectable viewing option information when the terminal is different from the fee-based subscriber terminal based on the comparing;
controlling the AP to transmit driving environment information of the terminal and the selected viewing option information to a DCAS Provisioning System (DPS) when a fee-based broadcasting payment request message is received after the providing of the selectable viewing option information; and
controlling the AP to terminate the AP when the prepared CA image appropriate for a driving environment of the terminal corresponding to the driving environment information and the viewing option information cannot be received after the transmitting of the driving environment information of the terminal and the selected viewing option information.

6. The method of claim 5, further comprising:
controlling the AP to terminate the AP when the fee-based broadcasting payment request message corresponding to the viewing option information cannot be received after the transmitting of the selectable viewing option information.

7. The method of claim 5, further comprising:
controlling the AP to enable the AP to verify the IPS access information and the image installation information, which correspond to the CA image identifier, when the AP receives the prepared CA image appropriate for the driving environment of the terminal from the DPS after the transmitting of the driving environment information of the terminal and the selected viewing option information;
controlling the AP to provide the terminal with the IPS access information and the image installation information; and
controlling the AP to command the IPS corresponding to the CA image identifier to download.

8. The method of claim 1, wherein the controlling of the IPS comprises:
controlling the IPS to receive a specific image code from the CAS server and to transmit the IPS access information to the CAS server;
controlling the IPS to receive, from the AP, a CA image download command with respect to the corresponding terminal after the transmitting of the IPS access information; and
controlling the IPS to transmit the CA image code to the terminal according to the command.

9. A DCAS comprising:
a receiving unit to receive a CA image file from a CAS server and to receive IPS access information from an IPS;
a transmitting unit to provide an AP with information about the received CA image file; and
a control unit to control the AP to provide a terminal with access information to the IPS and image installation information when the terminal joins a fee-based service based on verifying device information of the terminal, and to control the IPS to enable the terminal to receive a CA image code of the terminal based on the access information and the image installation information.

10. The system of claim 9, wherein, when an authenticated terminal is different from a fee-based subscriber terminal, the control unit controls the AP to request a payment request message for the terminal, to provide the terminal with selectable viewing option information, and to provide the terminal with the IPS access information and the image installation information.
